(19) United States
(12) Patent Application Publication
(10) Pub. No.: US 2003/0105876 A1
(43) Pub. Date: Jun. 5, 2003

(54) Automatic generation of verifiable customer certificates

(76) Inventors: Michael F. Angelo, Houston, TX (US); E. David Neufeld, Magnolia, TX (US)

Correspondence Address: CONLEY ROSE, P.C., P. O. BOX 3267, HOUSTON, TX, 77253-3267, US

(21) Appl. No.: 10/010,031

(22) Filed: Nov. 30, 2001

(51) Int. Cl. G06F 15/16

(52) U.S. Cl. 709/237

(57) ABSTRACT

A verification technique in which a client verifies a server includes the use of two different digital certificates—one certificate derived from and including the other certificate. One certificate is programmed into the server it is desired to verify. This certificate includes various values that are signed with a secure private key, which may be, for example, the private key of the manufacturer of the server or subsystem within the server. The second certificate is derived from and includes the first certificate. This latter certificate also includes one or more server identity values (e.g., IP address, domain name) and is signed by a second private key that is preferably different than the private key used to sign the first certificate. Both certificates must be verified successfully by a client before a secured communication is permitted to proceed.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to establishing a secure communication session between a client and a server. More particularly, the invention relates the automatic generation of verifiable certificates for use in confirming the identity of a server.

2. Background of the Invention

The Internet has made the dissemination of information across long distances easy and inexpensive. Further, the Internet has facilitated controlling one computer or computer system from a remote location. These types of remote activities create a security concern.

Suppose that a consumer wishes to conduct an on-line purchase of a product from a merchant. At some point in the transaction, the merchant will request the consumer to transmit confidential information, such as the consumer's name, address and, in particular, credit card number. It is possible for an unauthorized entity to intercept information transmitted between the server and client. This is generally called the “man-in-the-middle attack” in which an unauthorized entity makes itself appear to be the true merchant to which the consumer believes it is communicating. The consumer, believing it is in communication with the true merchant, sends confidential data to the man-in-the-middle. The man-in-the-middle forwards the information on to the true merchant, but retains a copy of the confidential data. As such, the confidentiality of the consumer's information is compromised and the consumer may be none the wiser.

To remedy this and other types of security breaches, the “secure sockets layer” (“SSL”) protocol was created to permit the consumer to verify the authenticity of the merchant before transmitting the consumer's confidential data. SSL's objective is to verify the identity of parties involved in a secure transaction and ensure that data transmission is protected from tampering or interception. The following is an overview of how SSL works. In this context and throughout this disclosure, the term “client” refers to the entity attempting to initiate a communication. The term “server” refers to the entity to which the client communicates and the entity whose identity is verified by the client. Typically, the server is the content provider while the client uses the services provided by the server. In the above vernacular, the consumer is the client and the merchant is the server.

The client initiates communication with the server by providing a variety of important information. The client sends the current level of SSL support, a random number and the encryption option it supports. The random number will eventually be used to generate a key for secure transmission. The server responds by providing similar information and its signed digital certificate. The server will select the version of SSL that will be used for the remainder of the session, generate its own random number and also present the encryption options it supports. The signed digital certificate will be used by the client to confirm the server's identity.

There are a number of tests that the signed certificate must pass to confirm the identity of the server. First, the client checks to make sure that the server's certificate has not expired. Second, the client checks to see if the certificate authority (“CA”) that issued the certificate is on the client's list of trusted CAs. The third step involves validating the server's private key used to sign the server's certificate with the public key on record with the CA. If the information in the CA certificate differs from what is contained in the digital signature, the public key will not decode the digital signature key and the server will not be validated. The final step involves verifying that the server's domain name listed on the server certificate matches the domain name of the server in question. This last step protects against the man-in-the-middle attack described above.

Although SSL is generally a very effective security mechanism, it is not without its deficiencies. First, cost to a server entity to participate in this process is fairly substantial. Also, SSL generally requires special technical expertise on the part of the server entity to configure the server for SSL participation typically requiring a network administrator or equivalent. For some types of server entities, such as web sites for large organization (e.g., Amazon.com), these deficiencies may not be too severe. However, for other organizations, particularly those that are cost sensitive and/or do not have sufficient technical expertise in-house, these problems are particularly troubling and, in fact, may preclude entry into on-line commerce.

The deficiencies of SSL are particularly problematic for computer equipment that is mass produced and used in the server-client context described above (i.e., a client verifies the authenticity of the server before transmitting information). The certificate provided by the server to the client typically includes the server's Internet Protocol (“IP”) address as well as its domain name (e.g., “www.mycompanyname.com”). Such equipment cannot be shipped from the factory with the certificates already stored on the equipment because the equipment will not be assigned IP addresses and domain names until purchased, installed, and turned on and booted up by the user of the equipment. As noted above, many such purchasers are inconvenienced by having to create their own certificates and, in fact, may not possess sufficient technical expertise to create the certificates. Further, the organization may not have the financial resources to commit to conventional SSL verification.

Accordingly, a solution to the aforementioned problem is needed. Such a solution should make it possible for clients to verify the authenticity of servers when establishing a secure communications link without the cost and technical expertise overhead of the conventional SSL protocol. Despite the advantages such a system would provide, to date no such system is known to exist.

### BRIEF SUMMARY OF THE INVENTION

The problems noted above are solved in large part by a verification technique in which a client verifies the signatures included in two different digital certificates provided by a server. One certificate is called a basic certificate (“B CERT”) and is programmed into the server, or whatever device or system it is desired to verify. The B CERT includes various values that are signed with a secure private key, which may be, for example, the private key of the manufacturer of the server or subsystem within the server. The second certificate is called the local certificate (“L CERT”) and is derived from and includes the B CERT. The L CERT also includes one or more server identity values (e.g., IP address, domain name) and is signed by a second private key that is preferably different than the private key used to sign the B CERT. The B CERT preferably is created at the factory and therefore present is in the server upon installation of the server. It should be understood that the B CERT may be present on a circuit board installed in the server.

The L CERT is created after an IP address, domain name, etc. is assigned to the server. The LCERT is created automatically by the server upon boot up, during another type of configuring process or at another time. The L CERT preferably is signed by another trusted private key.

In order for a client to communicate with the server, the client must verify the authenticity of the server. This process includes successfully verifying both certificates using the appropriate public keys. Because this verification technique includes basing one certificate on another certificate, a chain of trust is developed by which the server's identity can be verified remotely by a client. Further, the verification process does not require the use of conventional SSL techniques and the expense and technical expertise generally required to participate in the conventional SSL verification.

These and other advantages will become apparent upon reviewing the following disclosures.

### BRIEF DESCRIPTION OF THE DRAWINGS

For a detailed description of the preferred embodiments of the invention, reference will now be made to the accompanying drawings in which:

FIG. 1 shows a server and client system embodying the preferred embodiment of the invention;

FIG. 2 shows the steps performed by the server to automatically generate a verifiable certificate; and

FIG. 3 shows the steps performed by a client to verify the server's certificate.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. To the extent that any term is not specially defined in this specification, the intent is that the term is to be given its plain and ordinary meaning.

### DETAILED DESCRIPTION OF THE PREFERRED EMBODIMENTS

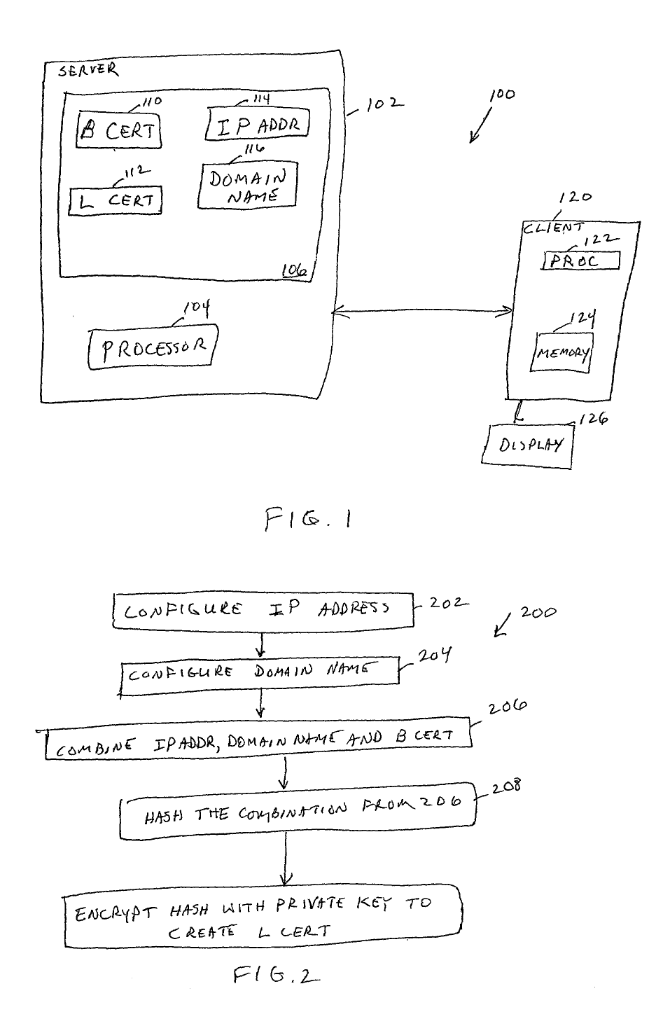

Referring now to FIG. 1, system 100 is shown constructed in accordance with a preferred embodiment of the invention. As shown, system 100 includes a server 102 and a client 120 in communication with one another via a network connection 122. The network connection 122 preferably comprises the Internet, but alternatively may comprise any type of communication link. The general function(s) performed by server 102 can be anything desired, such as hosting web pages, controlling an organization's computer system, etc. The server 102 preferably is a server computer, collection of computers or an entire network of computers within an organization. The client 120, which includes at least a processor 122 coupled to memory 124, preferably comprises a computer that can perform, if desired, a variety of functions. One function, however, preferably is to communicate with sever 102. The purpose of the communication with the server 102 might be to retrieve status information regarding the operation of the server, configure or reconfigure the server, or conduct other types of actions. In so doing, the client 120 may have to transmit various types of confidential information to the server 102 (e.g., passwords) or retrieve confidential information from the server. Accordingly, it is beneficial to the operator of the client system 120 to be able to verify the authenticity of the server 102 before engaging in a communication session with the server. Further, a plurality of clients 120 may couple to the server, each one independently verifying the authenticity of the server. It should be understood that in general the invention applies to one device verifying the authenticity of another device even out of the server/client context.

As shown, server 102 includes a processor 106 coupled to a memory 106. Other devices may be included in the server, but are not shown in FIG. 1 for sake of simplicity. Such other devices may include a keyboard, mouse, display, other types of input/output circuitry and devices, additional processors, additional memory, etc. The authentication process generally includes the use of various values stored in the server 102. Several of such values are shown in memory 106. The values include a basic certificate (“B CERT”) 110, a local certificate (“L CERT”) 112, an Internet Protocol (“IP”) address 114, and a domain name 116. The memory 106 in which these values are stored may comprise non-volatile memory (e.g., a hard drive, various types of read only memory, etc.), volatile memory (e.g., various types of random access memory) or a combination of volatile and non-volatile memory. In one embodiment of the invention, a circuit board may be installed into the server 102 that provides communication capabilities. Such a board (not specifically shown in FIG. 1) may include a processor and memory on which the values shown in FIG. 1 are stored.

In accordance with the preferred embodiment of the invention, two certificates are used to verify the authenticity of the server by the client. The B CERT preferably is programmed or otherwise loaded into the server during the manufacturing process. The B CERT preferably includes a public key associated with server, a private key to permit the subordinate L CERT to be signed by the B CERT, a serial number associated with the server, a uniqueness value (e.g., a random number) and a digital signature. Different or additional values may be included in the B CERT as desired. The public key and serial number may be associated with the server or circuit board contained within the server. The serial number, which is not required, preferably is unique to the server and distinguishes that server from all other servers. The serial number can be replaced within any alphanumeric, binary or other value or string that uniquely distinguishes the server from other devices.

The digital signature preferably comprises a signed (i.e., encrypted) hash of the values listed above. That is, the values listed above are combined together in some suitable fashion and processed by a suitable hash function. The output value from the hash function is then encrypted using a private key to create the signature. The private key used to sign the hash may be a private key associated with the manufacturer of the server or device or circuit board within or coupled to the server. In accordance with one embodiment of the invention, all servers 102 may include the same B CERT. As such, the B CERTs may not include a serial number unique to any one particular server. Alternatively, the servers 102 may include different B CERTs—different in terms of the serial numbers and/or private keys used to sign the hashes.

Being signed by a secure private key, the B CERT represents a certificate that generally verifies the authenticity of the server hardware on which the certificate is stored. To provide further verification assurance, a second certificate—the L CERT 112—is automatically created by the server 102 using the B CERT 110. The L CERT 112 preferably includes one or more values that identify the server such as an Internet Protocol (“IP”) address and domain name after such values are assigned or otherwise provided to the server 102. The L CERT may also include other configuration information as desired. These values (the B CERT, IP address, domain name) are then processed by a hash function, which may be the same or different than the hash function used to create the B CERT, and signed by a private key. This private key preferably, although not necessarily, is different than the private key used to sign the B CERT. The private key used to sign the L CERT 112 preferably is associated with the server and generated in some suitable manner by an operator of the server or by software running on the server. The user should add their B CERT to the browser's trusted domain list. After this happens, subordinate certificates (“L CERTs”) will be accepted by the browser without complaining.

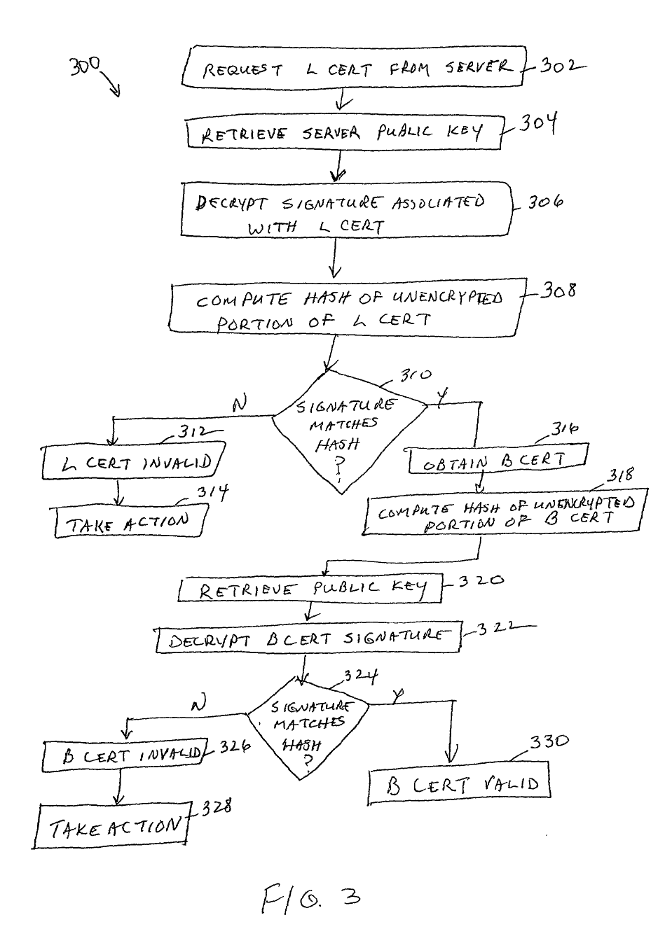

FIG. 2 illustrates the process 200 by which the L CERT 112 is created. This process may be performed upon initial boot up of the server or any other subsequent boot sequence or at any other desired time such as when the server's IP address and/or domain name change. In steps 202 and 204, the server 102 is configured to generate values identifying the identity and location of the server such as an IP address (202) and a domain name (204). Then, these identity/location values are combined together with the B CERT 110 and perhaps other values as noted above (step 206). In step 208 these values are hashed and in step 210, the resulting hashed value is encrypted using the server's private key.

Once the server 102 creates its L CERT 112, client devices 120 can then establish a communication with the server using the B CERT 110 and L CERT 112 to verify the server's authenticity. FIG. 3 shows one suitable embodiment of this process. In this process, both certificates—the B CERT 110 and L CERT 112—may be verified. The process 300 in FIG. 3 includes steps 302-330. When client 120 wishes to establish a communication session with the server 102, the client first requests the L CERT 112 from the server in step 302. Then, in step 304, the client retrieves the public key associated with the server. As is well known, public and private keys are typically generated as a corresponding pair. Thus, the public key retrieved in step 304 is the public key that corresponds to the private key that was used to sign the L CERT. This public key may previously have been stored in the client, provided to the client by the server as part of the certificate or in a separate communication from the server or other device.

Once retrieved, the public key is used to decrypt the digital signature portion of the L CERT (step 306). Then, in step 308, the unencrypted portion of the L CERT is hashed by the client 120 using the same hash algorithm used to create the hash for the L CERT in the first place. If the L CERT is authentic, the unencrypted signature from step 306 should match the hash computed in step 308. Accordingly, in step 310, the hash from step 308 is compared to the decrypted signature from step 306. If these values do not match, then the L CERT is determined to be invalid in step 312 and an appropriate action is taken in step 314. Suitable actions could include simply terminating the attempt to initiate a communication session between the client and server, reporting or broadcasting the failed verification as a potential security breach to other devices or administrators coupled to the server 102 and client 112, etc.

If, however, the two hashes regarding the L CERT match in step 310, the local certificate is determined to be valid and the B CERT 110 is transmitted by the server to the client preferably at the client's request (step 316). Then, in step 318, the client computes a hash of the encrypted portion of the B CERT. The hash function used in step 318 preferably is the same hash function used to generate the B CERT. In step 320, a public key is retrieved that is associated with the private key that was used to sign the B CERT. This public key may previously have been stored in the client, provided to the client by the server as part of the certificate or in a separate communication from the server or other device. Once retrieved, this public key is used in step 322 to decrypt the digital signature portion of L CERT 112.

The hashes are compared in step 324 and if there is a mismatch, the B CERT 110 is determined to be invalid (326) and an appropriate action is taken in step 328. This action may include terminating the attempt to initiate a communication session between the client and server, reporting or broadcasting the failed verification as a potential security breach to other devices or administrators coupled to the server 102 and client 112, etc. As such, the action taken in step 328 to a failed B CERT verification may the same as the action taken in step 314 to a failed L CERT verification. Alternatively, the actions taken response to failed L CERT and B CERT verifications may be different. If, however, the hashes match in step 324, then in step 330, the B CERT is considered authentic and the communication session between the client and the server is permitted to continue.

It should be understood that the order of many of the steps in FIGS. 2 and 3 can be changed from that shown. For example, the process 300 of FIG. 3 can include the client requesting both the B CERT and L CERT certificates 110, 112 before verifying either certificate. That is, the client need not wait to request and receive the B CERT until the L CERT is successfully verified.

In this manner, the server is able to automatically generate a verifiable certificate that provides the client reasonable assurance of authenticity. The certificate (“L CERT”) is based on another certificate (“B CERT”) and is signed by a private key pertaining to the server. The B CERT, in turn, is signed by a trusted authority, such as the manufacturer of the server. This process avoids the need to use conventional Certificate Authority (“CA”) and expend the substantial financial and technical resources to participate in conventional SSL verification.

As explained above, if desired the B CERT 110 may include a serial number unique to the server in which the B CERT is stored. This serial number, which would make each B CERT different from other B CERTs in other servers, is useful to provide additional verification. Specifically, by including a server-specific piece of information or value in the B CERT further assurance is provided regarding the server's authenticity.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of establishing a secured communication session across a remote network connection, comprising:
(a) receiving a first certificate that includes a first digital signature;
(b) obtaining a first public key;
(c) using the first public key to verify the first digital signature;
(d) if the first digital signature in (c) is successfully verified, receiving a second certificate that includes a second digital signature;
(e) obtaining a second public key; and
(f) using the second public key to verify the second digital signature.

2. The method of claim 1 wherein said first and second digital signatures are signed with different private keys.

3. The method of claim 1 wherein said second certificate includes at least a portion of said first certificate.

4. The method of claim 1 wherein (c) includes decrypting a portion of said first certificate to recover a first hash value.

5. The method of claim 4 wherein (c) also includes computing a hash of at least a portion of said first certificate to produce a first computed hash value.

6. The method of claim 5 wherein said first hash value is compared to said first computed hash value.

7. The method of claim 6 wherein (c) further includes determining said first digital signature is successfully verified if said first hash value matches said first computed hash value.

8. The method of claim 1 wherein (f) includes decrypting a portion of said second certificate to recover a second hash value.

9. The method of claim 8 wherein (f) also includes computing a hash of at least a portion of said second certificate to produce a second computed hash value.

10. The method of claim 9 wherein said second hash value is compared to said second computed hash value.

11. The method of claim 10 further including successfully verifying said second digital signature if said second hash value matches said second computed hash value.

12. A method of establishing a secured communication session across a remote network connection, comprising:
(a) receiving first and second certificates that include first and second digital signatures, respectively;
(b) obtaining first and second public keys;
(c) using the first public key to verify the first digital signature;
(d) if the first digital signature in (c) is successfully verified, verifying the second digital signature; and
(e) permitting the communication session to occur if both said first and said second digital signatures are successfully verified.

13. The method of claim 12 wherein said first and second digital signatures are signed with different private keys.

14. The method of claim 12 wherein said second certificate includes at least a portion of said first certificate.

15. The method of claim 12 wherein (c) includes using said first public key to decrypt a portion of said first certificate to recover a first hash value.

16. The method of claim 15 wherein (c) also includes computing a hash of at least a portion of said first certificate to produce a first computed hash value.

17. The method of claim 16 wherein (c) includes comparing said first hash value to said first computed hash value.

18. The method of claim 17 wherein (c) further includes determining that said first digital signature is successfully verified if said first hash value matches said first computed hash value.

19. The method of claim 12 wherein (c) includes decrypting a portion of said second certificate to recover a second hash value.

20. The method of claim 19 wherein (c) also includes computing a hash of at least a portion of said second certificate to produce a second computed hash value.

21. The method of claim 20 wherein (c) includes comparing said second hash value to said second computed hash value.

22. The method of claim 21 further including successfully verifying said second digital signature if said second hash value matches said second computed hash value.

23. A method of creating a remotely verifiable certificate, comprising:
(a) retrieving a first signed certificate;
(b) combining together said first signed certificate with other values;
(c) computing a hash of the combination from (b); and
(d) signing said hash from (c) with a private key.

24. The method of claim 23 wherein said other values in (b) includes an IP address.

25. The method of claim 23 wherein said other values in (b) includes a domain name.

26. A computer, comprising:
a processor; and
a memory coupled to said processor;
wherein said memory includes storage for a first certificate and a second certificate, said second certificate derived from said first certificate.

27. The computer system of claim 26 wherein said processor combines at least a portion of said first certificate with additional values, computes a hash of said combination, and encrypts said hash with a private key.

28. The computer system of claim 27 wherein said additional values include an IP address.

29. The computer system of claim 27 wherein said additional values include a domain name.

30. The computer system of claim 26 wherein said first certificate includes a serial number.

31. The computer system of claim 26 wherein said first certificate is not created by the server.

32. A client system, comprising:
a processor; and
a memory coupled to said processor; and
a connection to a communication link to a server;
wherein said processor requests a first certificate from the server, verifies a first digital signature associated with said first certificate, and if said first digital signature is successfully verified, requests a second certificate from said server and verifies a second digital signature associated with said second certificate.

33. The client system of claim 32 wherein the client uses two different public keys to verify the first and second digital signatures.

34. A client system, comprising:
a processor;
a memory coupled to said processor; and
a connection to a communication link to a server;
wherein said processor requests a first certificate and a second certificate from the server, verifies a first digital signature associated with said first certificate, and if said first digital signature is successfully verified, verifies a second digital signature associated with said second certificate.

35. The client system of claim 34 wherein the client uses two different public keys to verify the first and second digital signatures.
